(19) United States
(12) Patent Application Publication
(10) Pub. No.: US 2005/0042934 A1
(43) Pub. Date: Feb. 24, 2005

(54) Electrical connector and method of making the same

(76) Inventors: Hua Yin Huang, Kunsan (CN); Nick Lin, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/925,264

(22) Filed: Aug. 23, 2004

(30) Foreign Application Priority Data
Aug. 22, 2003 (TW) 92215274

(51) Int. Cl. H01R 11/22

(52) U.S. Cl. 439/733.1

(57) ABSTRACT

An electrical connector includes a dielectric housing and a number of contacts. One side of the dielectric housing defines a number of through passageways for receiving the contacts. The contact includes a retention portion to secure the contact in the dielectric housing. The retention portion defines at least one sunken portion. The housing is stamped out a corresponding number of projecting portions after the contacts are inserted into the housing. The projecting portions engage into sunken portions of the contacts, thereby securing the contacts in the housing.

### BACKGROUND OF THE INVENTION

1. Field of The Invention

The present invention relates to an art of electrical connectors, more specifically, to an electrical connector for electrically connecting a memory module or the like to a printed circuit board.

2. Description of Related Art

With the development of electronic industry, miniaturization and high speed of an electrical connector is increasingly required. As a result, the structure of the connector turns to be increasingly complex and manufacturing of the electrical connector becomes increasingly difficult. For example, in order to prevent terminals from loosening in a housing of the electrical connector, a conventional technology is provided to stamp one side of the housing where the terminal is secured nearby. Therefore, an interference between the terminal and the housing is gained by proper deformation of the housing by stamping, which provide a firm securing of the terminal in the housing.

Referring to FIGS. 7-13, a conventional electrical connector for connecting a memory module to a PCB is shown. The electrical connector includes a longitudinal dielectric housing 60 and a number of terminals 70 received in the housing 60. The housing 60 defines a lengthwise inserting face 61, an lower face 62 opposite to the inserting face 61, and two opposite side walls 63 perpendicular to both the inserting face 61 and lower face 62. A number of receiving holes 65 cut through housing 60 from inserting face 61 to lower face 62. Each receiving hole 65 is defined with a first mating surface 651 and a second mating surface 652, both parallel to the side wall 63, and the first mating surface 651 closer to the side wall 63. The terminal 70 includes a sheet-like retention portion 72, an arcuate contacting portion 74 extending from an upper end of the retention portion 72 and an inserting portion 76 extending from a lower end of the retention portion 72. The retention portion 72 protrudes a pair of stoppers 78 along two opposite sides of the retention portion. The stoppers 78 are used to control the depth of the terminal 70 inserted into the housing 60. Furthermore, the retention portion 72 has a first and a second retention faces 721, 722 for interferentially mating with the first and second mating surfaces 651, 652 respectively. The contacting portion 74 is used for contacting a golden finger of a memory module or the like. The inserting portion 76 is soldered to a printed circuit board.

In assembling the electrical connector, insert the terminals 70 through the inserting face 61 into the receiving holes 65 until the stoppers 78 are blocked against the housing 60, mount the connector onto the printed circuit board, the inserting portion 76 of the terminal 70 being inserted into a hole (not shown) defined beforehand in a printed circuit board corresponding to the terminal 70, solder the inserting portion 76 to the printed circuit board, so electrical connection between the electrical connector and the PCB is defined.

However, in said mounting, all the terminals 70 of the connector need to be inserted into corresponding holes in the circuit board at the same time, and it is impossible to align each of the terminals 70 to corresponding hole synchronously, so some of the terminals 70 tend to draw back and even release from the housing 60 during the insertion. In order to insure the quality of the electrical connection between the electrical connector and the PCB, the retention forces of the terminals 70 need to be strengthened.

To improve the orientation of the terminals 70 in the receiving holes 65, a conventional technology is to dimple a line of dents 69 equidistantly arranged on the side wall 63 of the housing 60. With the dents deflecting of the side walls 63, the first mating surfaces 651 displace inwardly partly. So the amount of an interference between the terminals 70 and the first mating surface 651 is enlarged and the force of the housing 60 gripping the contact 70 increases. In order to further improve the orientation of the terminals 70 in the receiving holes 65, conventionally, a number of protrusions 7211 are stamped out on the first retention face 721 of the retention portion 72 to increase the amount of the interference between the terminal 70 and the housing 60.

However, when the retention portion 72 is stamped with a protrusion on the first retention face 721, there always is a recess 7222 defined on the second retention face 722. So when the first mating surface 651 is stamped towards the first retention face 721 of the terminal 70, the protrusions 7211 are usually pressed down, and thus, the retention force by of the terminal 70 in the housing 60 is impaired.

### SUMMERY OF THE INVENTION

Accordingly, the object of the present invention is to provide an electrical connector with an firm retention between a contact and a housing thereof.

Another object of the present invention is to provide a method to make an electrical connector with an excellent retention between a contact and a housing thereof.

In order to achieve the above-mentioned object, an electrical connector in accordance with a preferred embodiment of the present invention is provided. The electrical connector includes a dielectric housing and a number of contacts. The dielectric housing defines a number of passageways for receiving the contacts. The contact includes at least a retention portion to fasten itself in the dielectric housing. The retention portion further defines at least one sunken portion by its lateral side. The housing is stamped out corresponding number of projecting portions inside each of the passageways. The projecting portions engage into the sunken portions, thereby securing the contacts in corresponding passageways of the housing.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of an electrical connector in accordance with a preferred embodiment of the present invention;

FIG. 2 is an front view of a contact of the electrical connector;

FIG. 3 is a left view of the contact of FIG. 2;

FIG. 4 is a cross-sectional view of the electrical connector of FIG. 1 taken along a line IV-IV before the electrical connector is stamped;

FIG. 5 is an enlarged view of a circled part IV of FIG. 4;

FIG. 6 a cross-sectional view of the part IV taken along a line VI-VI of FIG. 5.

FIG. 7 is an isometric view of a conventional electrical connector related to the present invention;

FIG. 8 is a front view of a terminal of the conventional electrical connector shown in FIG. 7;

FIG. 9 is a left view of the terminal of FIG. 8;

FIG. 10 is an enlarged view of a circled part X of FIG. 9;

FIG. 11 is a cross-sectional view along line of XI-XI of FIG. 7 before the electrical connector is stamped;

FIG. 12 is an enlarged view of a circled part XII of FIG. 11 before the connector is stamped; and

FIG. 13 is similar to FIG. 11, but showing the connector post stamped.

### DETAILED DESCRIPTION OF PREFERRED EMBODIMENT OF THE INVENTION

Reference will now be made to the drawings to describe the present invention in details.

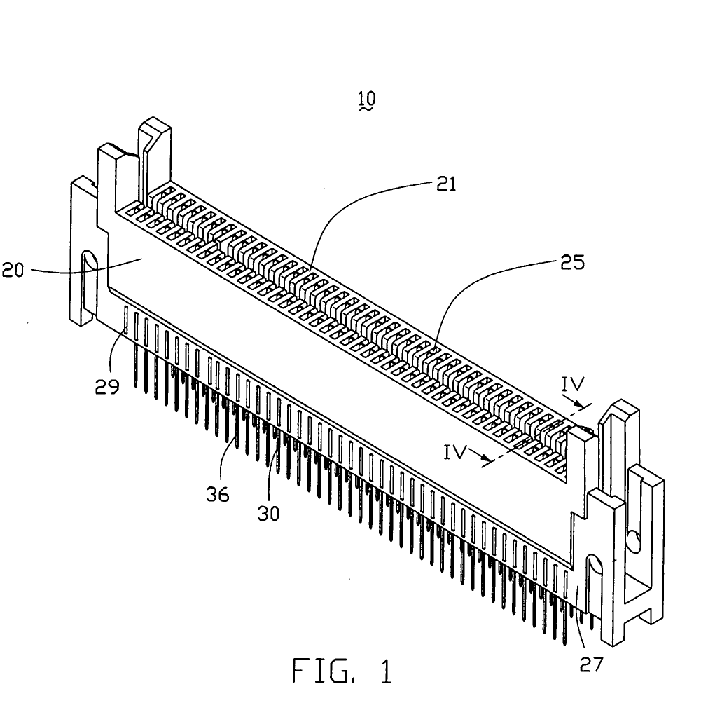

Referring to FIG. 1, an electrical connector 10 in accordance with a preferred embodiment of the present invention is shown. The connector 10 is mainly used for connecting a memory module (not shown) or the like to a printed circuit board (not shown). The connector 10 includes a longitudinal dielectric housing 20 and a number of contacts 30 received in the housing 20.

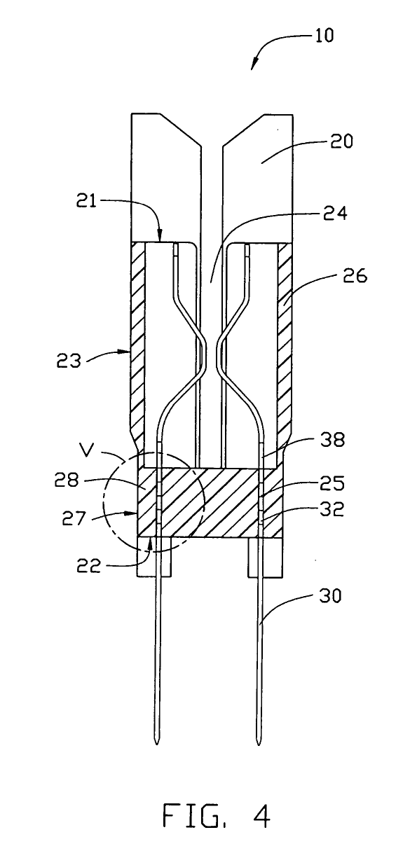

Referring to FIGS. 1, 4 and 5, the dielectric housing 20 defines a installing surface 22, an inserting surface 21 opposite to the installing surface 22 and a first outside face 23 perpendicular to both the installing surface 22 and the inserting surface 21. There is a second outside face 27 connected parallel to the first outside face 23 by a step. A lengthwise trench 24 for receiving the memory module is defined in the middle of the inserting surface 21. The housing 20 forms a longitudinal bottom wall 28 and two side walls 26 generally perpendicularly connecting the bottom wall 28 and parallel to a longitudinal direction of housing 20. The trench 24 is defined by the bottom wall 28 and two side wall 26. Near the second outside face 27, two lines of passageways 25 equidistantly is arranged along and in communication with the trench 24 cutting through the housing 20 from the inserting surface 21 to the installing surface 22. Each of the passageways 25 defines two opposite mating surfaces 251 parallel to the second outside face 27;

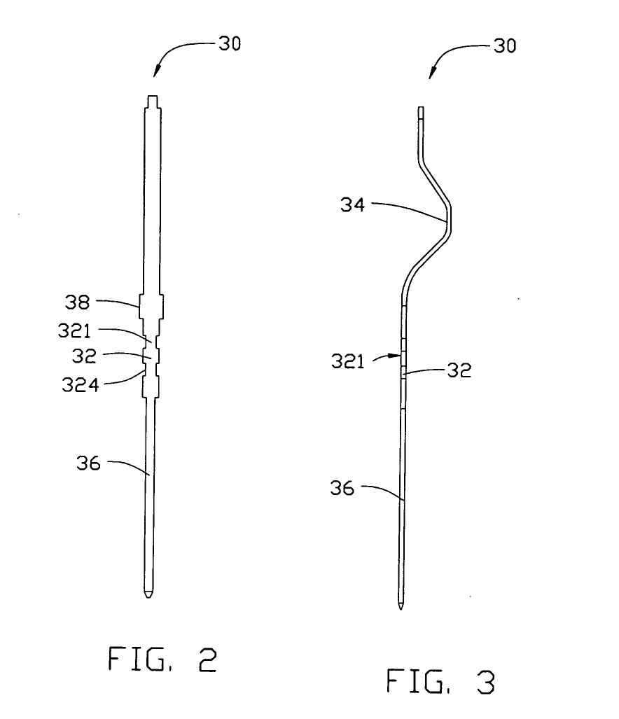

Referring to FIGS. 2, 3, 4 and 5, each of contacts 30 is received in a corresponding passageway 25. The contact includes a sheet-like retention portion 32, an arcuate contacting portion 34, a pair of orientation portion 38 and an inserting portion 36. The retention portion 32 is used for securing the contact 30 in the bottom wall 28 of the housing 20. The retention portion 32 is formed with two opposite retention surfaces 321 to mate with the mating surfaces 251 respectively. The retention portion 32 further symmetrically defines two pairs of rectangular grooves 324 cutting through by two opposite lateral sides. The contacting portion 34 slantwise and upwardly extends from one upper end of the retention portion 32 for contacting the memory module. The orientation portions 38 extends laterally from a part between the retention portion 32 and the contacting portion 34. The inserting portion 36 extends downwardly from the lower end of the retention portion 32 out of the housing 20 for being mounting on a printed circuit board in a through-hole fashion.

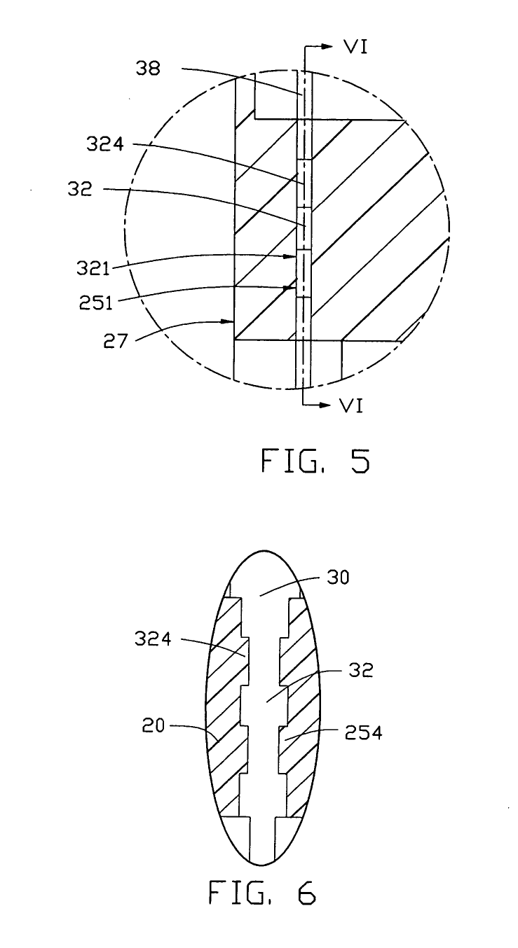

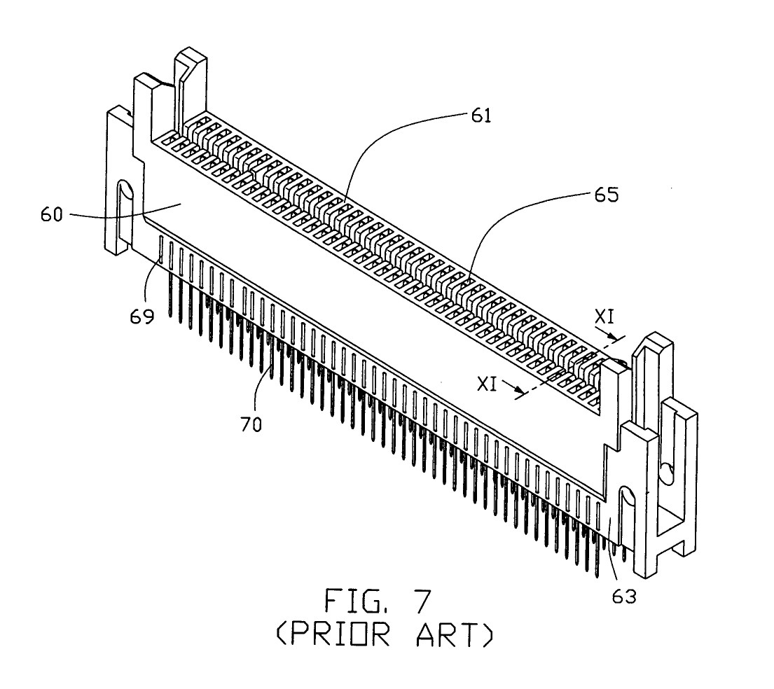

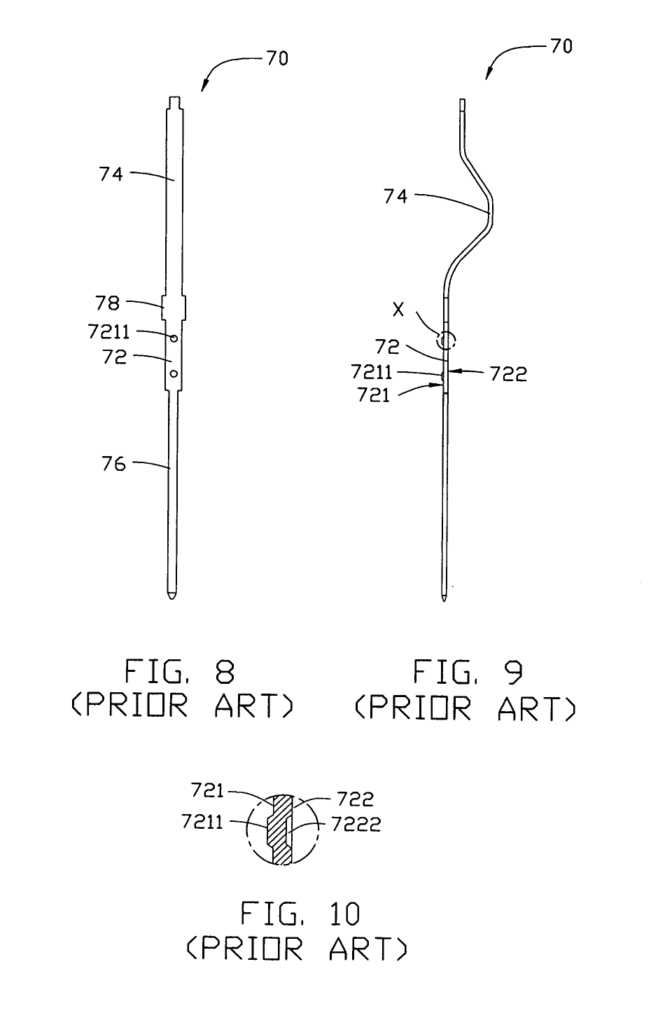

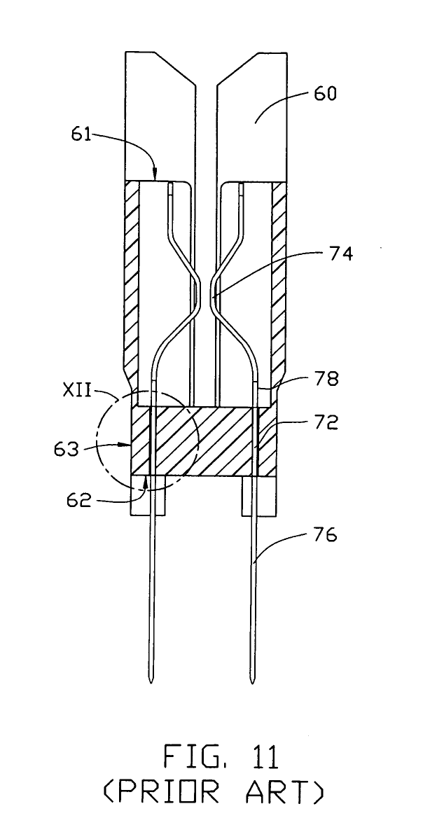

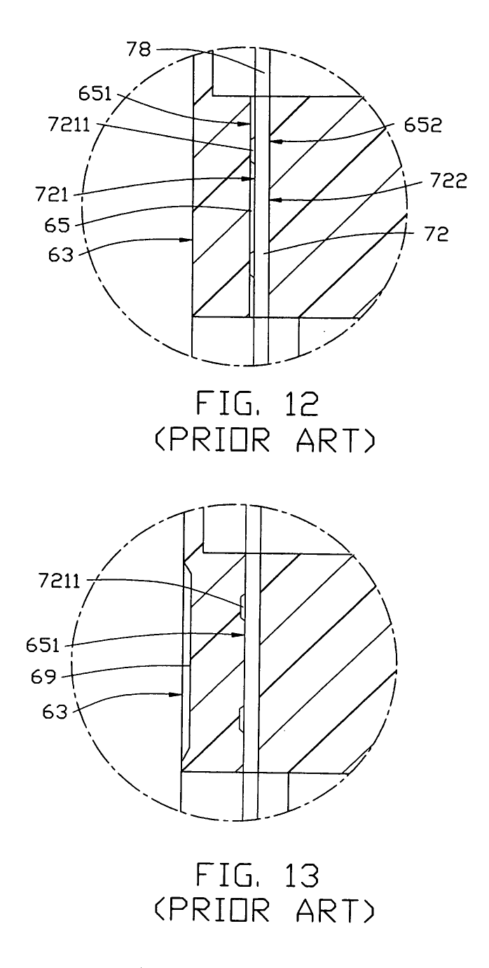

Referring to FIGS. 1-6, in assembling the connector 10, provide a housing 20 and a number of contacts 30, insert the contact 30 into the passageway 25 through the inserting surface 21 till orientation portions 38 reach the bottom wall 28, stamp the second outside face 27 of the housing 20 where corresponding to the sunken portion 324 of the contact 30, consequently, a line of dents 29 left, parts of material of the housing 20 extruded into the sunken portions 324 to form projecting portions 254. Therefore, the contact 30 is firmly secured in the housing 20 by projecting portion 254.

While preferred embodiment in accordance with the present invention has been shown and described, equivalent modifications and changes known to persons skilled in the art according to the spirit of the present invention are considered within the scope of the present invention as defined in the appended claims.

1. An electrical connector for connecting a memory module or the like to a printed circuit board, comprising:
a dielectric housing defining a plurality of passageways;
a plurality of contacts received in the passageways, each of the contacts forming a retention portion for securing the contact in the housing, the retention portion defining a retention surface and at least one sunken portion in the retention surfaces;
wherein the housing is stamped out at least one projecting portion inside the passageway, the projecting portion mating with the at least one sunken portion to secure the contact in the housing.

2. The electrical connector as claimed in claim 1, wherein the housing further defines an outside face adjacent to the passageways for facilitating being stamped on.

3. The electrical connector as claimed in claim 2, wherein each of the passageways defines a mating surface parallel to the outside face, the retention surfaces mating with corresponding mating surface.

4. The electrical connector as claimed in claim 3, wherein the housing further defines an inserting surface substantially perpendicular to the outside face, and a longitudinal trench in the inserting surface, the passageways being arranged along and beside the trench.

5. The electrical connector as claimed in claim 4, wherein the housing further forms a bottom wall and two side walls perpendicularly connecting the bottom wall to cooperatively define the trench, each of the contacts further comprising an arcuate contacting portion extending upwardly from the retention portion towards the side wall.

6. The electrical connector as claimed in claim 5, the contact further comprises an orientation portion having at least one protrusion formed between the retention portion and the contacting portion for controlling the depth that the contact is inserted into the housing.

7. An electrical connector for connecting an electrical device to a printed circuit board, comprising:
a longitudinal dielectric housing having an outside face and a plurality of passageways near the outside face;
a plurality of contacts received in the passageways, the contact forming a retention portion, the retention portion defining two retention surfaces opposite to each other;
wherein at least one of the retention surfaces defines at least one sucked portion, and the housing forms at least one projecting portion for mating with the sucked portion.

8. The electrical connector as claimed in claim 7, the housing further comprises an inserting surface substantially perpendicular to the outside face and an installing surface opposite to the inserting surface, each of the contacts further comprising an arcuate contacting portion extending from the retention portion towards the side wall.

9. The electrical connector as claimed in claim 8, the sunken portions each has a rectangular configuration through the opposite retention surfaces.

10. An method for making an electrical connector for connecting an electrical device module to a printed circuit board, comprising:
providing a dielectric housing having an outside face and a plurality of passageways arranged adjacent to the outside face, each of the passageways defining a mating surface generally parallel to the outside face;
providing a plurality of contacts, each of the contact forming a retention portion, the retention portion defining a retention face for engaging with the mating surface and at least one sunken portion in the retention face;
inserting the contacts into the housing till the retention portion fits in the passageway; and
stamping a line of dents on the outside face to extrude parts of housing into the sunken portion to form a projecting portion inside the passageway, wherein the projecting portion mates with the sunken portion to strengthen securing of the contact in the housing.

11. The method as claimed in claim 10, wherein the housing further defines an inserting surface substantially perpendicular to the outside face and an installing surface opposite to the inserting surface, each of the contacts further comprising an arcuate contacting portion extending from the retention portion for contacting said IC module.

12. The method as claimed in claim 11, wherein the housing further comprises a longitudinal trench in the inserting surface, the passageways being arranged beside the trench.

13. The method as claimed in claim 12, wherein the contact further comprises an orientation portion having at least one protrusion formed between the retention portion and the contacting portion.

14. The method as claimed in claim 13, wherein the sunken portion has a rectangular configuration cutting through the retention portion by one lateral side.

15. The electrical connector as claimed in claim 1, wherein the retention portion defines a plurality of shoulders and results in large and small segments alternatively arranged with each other along a lengthwise direction of said retention portion.
